(19) United States
(12) Patent Application Publication
(10) Pub. No.: US 2012/0046152 A1
(43) Pub. Date: Feb. 23, 2012

(54) BAG NECK SEALER

(76) Inventor: Hsiu-Man YU CHEN, Tan Tzu Township (TW)

(21) Appl. No.: 12/859,146

(22) Filed: Aug. 18, 2010

(51) Int. Cl. B31B 1/14

(52) U.S. Cl. 493/223

(57) ABSTRACT

A bag neck sealer includes a base. The base includes an installation wheel, a rotary wheel, a press plate, a movable blade unit and a fixed blade unit. The fixed blade unit has a seat. The seat includes a fixed blade and a protective piece thereon. The protective piece is connected with an elastic member to be against one side of the fixed blade opposite to the seat to shield the edge of the fixed blade. Therefore, when the user operates the bag neck sealer, the user's fingers can be protected from the fixed blade through the protective piece, preventing the fingers from being hurt so as to enhance the safety of the bag neck sealer.

### BACKGROUND OF THE INVENTION

1. Field of the Invention

The present invention relates to a bag neck sealer.

2. Description of the Prior Art

A plastic bag is used to carry articles. In order to prevent the fall of the articles, a bag neck sealer can be used to seal the open end of the bag. Referring to FIG. 1, a conventional bag neck sealer comprises a base 1. The base 1 has a guide trough 2 thereon, and an installation wheel 3 is installed on the base 1. A rotary wheel 4, a press plate 5, a movable blade unit 6 and a fixed blade unit 7 are provided close to the guide trough 2. When using the bag neck sealer, the user has to install a roll of adhesive tape 8 on the installation wheel 3 and pull out the tape to be adhered on the press plate 5. After that, the open end of the bag to be sealed is slid into the guide trough 2 to seal the open end of the bag by the rotary wheel 4 and the press plate 5. Finally, the movable blade unit 6 is to cut off the tape and the fixed blade unit 7 is to cut off the unnecessary portion of the bag to complete the seal of the bag. However, the fixed blade unit 7 of the conventional bag neck sealer is disposed at an outer side of the base 1, and there is no protection device. When operating the bag neck sealer, the fingers of the user may be hurt. Accordingly, the inventor of the present invention has devoted himself based on his many years of practical experiences to solve this problem.

### SUMMARY OF THE INVENTION

The present invention is to provide a bag neck sealer which comprises a base. The base has a guide trough and an installation wheel thereon. A rotary wheel, a press plate and a movable blade unit are provided close to the guide trough. A fixed blade unit is provided on one side of the base and located close to the guide trough. The fixed blade unit has a seat. The seat has a cutting slot corresponding to the guide trough of the base. The seat comprises a fixed blade. The fixed blade has an edge across the cutting slot. The seat further comprises a protective piece. The protective piece is connected with an elastic member to be against one side of the fixed blade opposite to the seat to shield the edge of the fixed blade. Therefore, when the user operates the bag neck sealer, the user's fingers can be protected from the fixed blade through the protective piece, preventing the fingers from being hurt so as to enhance the safety of the bag neck sealer.

### BRIEF DESCRIPTION OF THE DRAWINGS

FIG. 1 is a perspective view of a conventional bag neck sealer;

FIG. 2 is a perspective view according to a preferred embodiment of the present invention;

FIG. 3 is a cross-sectional view according to the preferred embodiment of the present invention;

FIG. 4 is an exploded view of a fixed blade unit according to the preferred embodiment of the present invention;

FIG. 5 is a cross-sectional view of the fixed blade unit according to the preferred embodiment of the present invention;

FIG. 6 is a schematic view showing the preferred embodiment of the present invention when in use; and

FIG. 7 is a schematic view to show the operation of the preferred embodiment of the present invention when in use.

### DETAILED DESCRIPTION OF THE PREFERRED EMBODIMENTS

Embodiments of the present invention will now be described, by way of example only, with reference to the accompanying drawings.

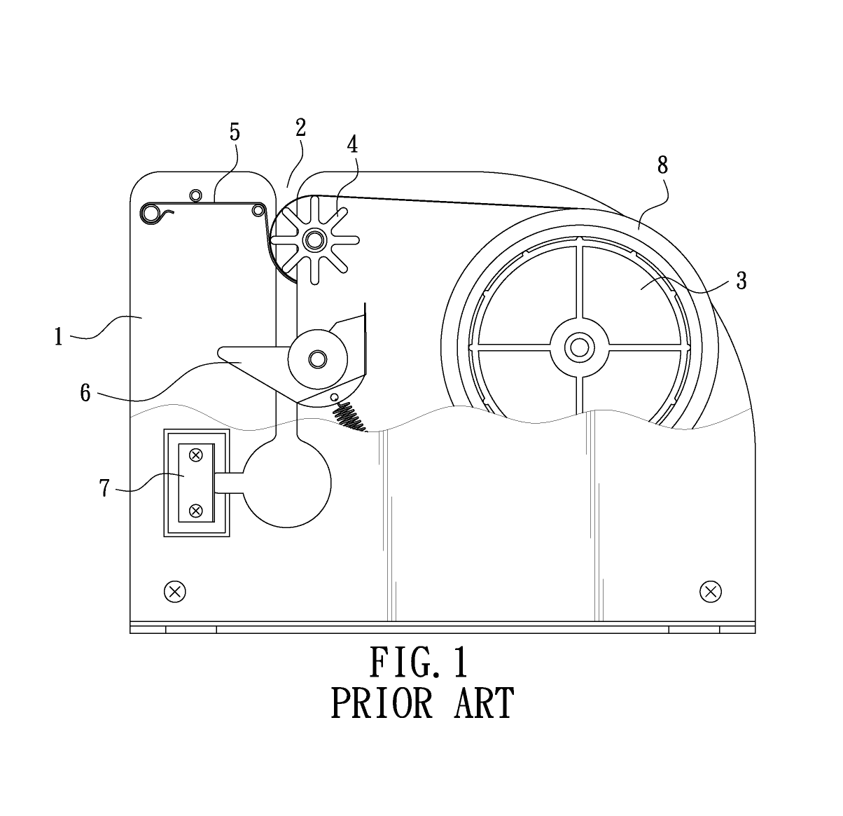

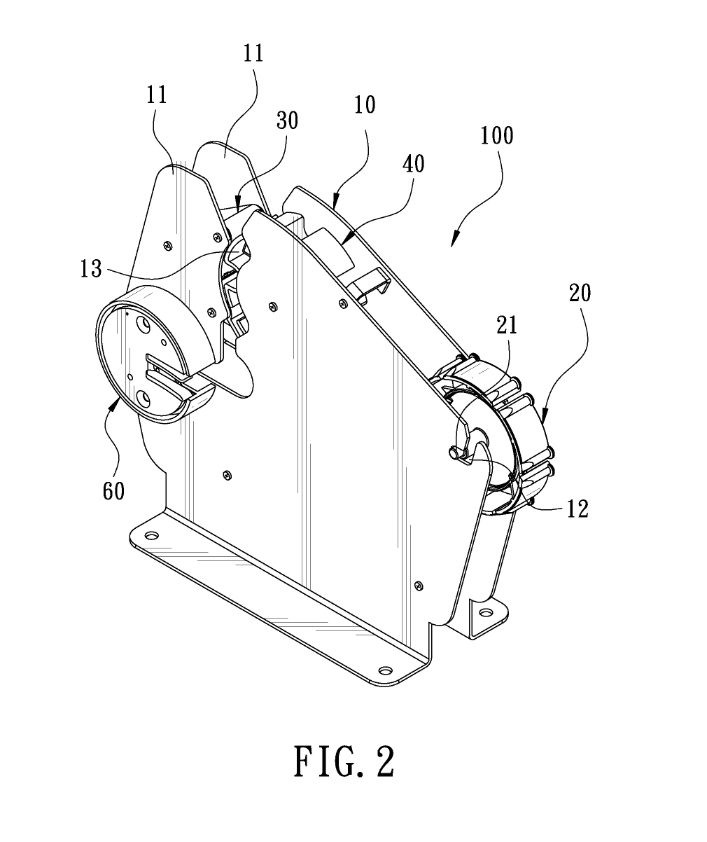

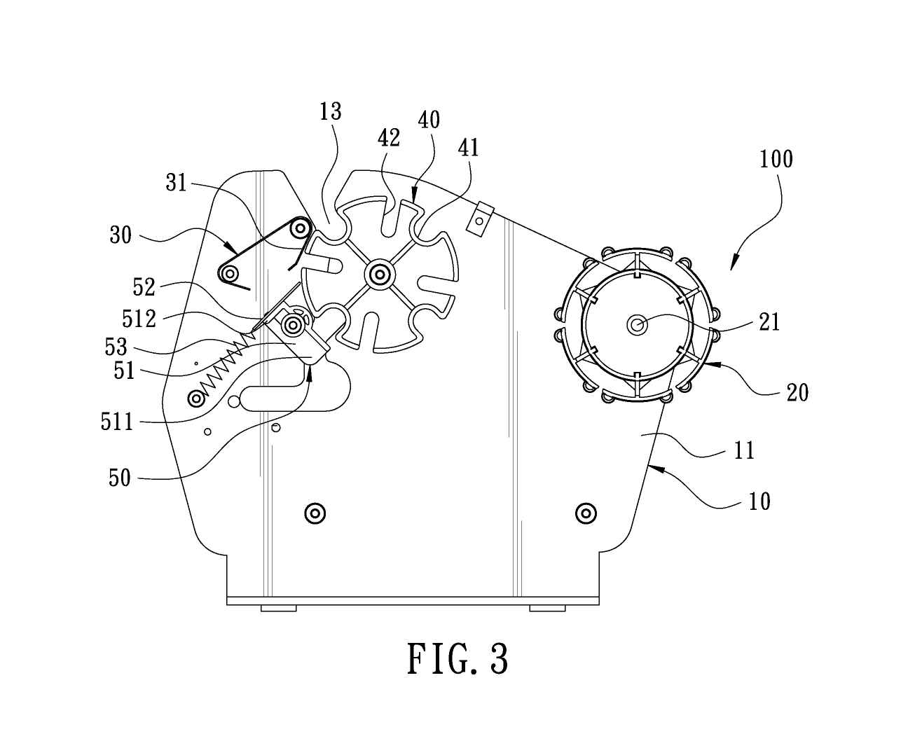

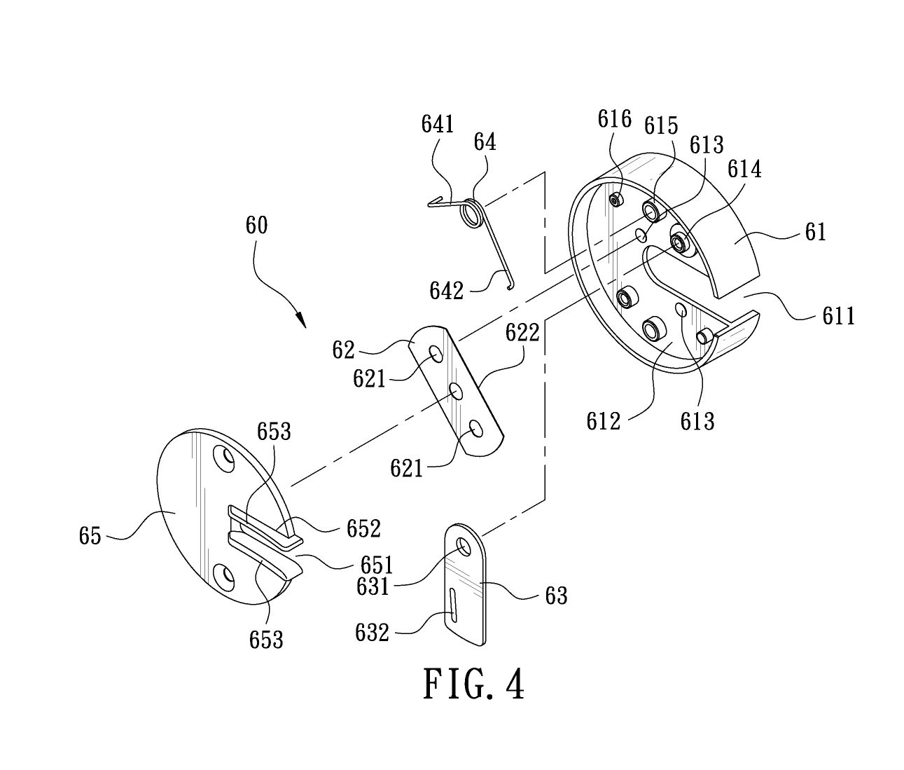

As shown in FIG. 1 to FIG. 5, a bag neck sealer 100 according to a preferred embodiment of the present invention comprises a base 10, an installation wheel 20, a press plate 30, a rotary wheel 40, a movable blade unit 50, and a fixed blade unit 60.

The base 10 comprises two standing plates 11 each having a fixing trough 12 and a guide trough 13 at an upper portion thereof.

The installation wheel 20 has a pair of pivots 21 protruding from two sides thereof. The installation wheel 20 is pivotally connected in the fixing troughs 12 of the two standing plates 11 of the base 10.

The press plate 30 is disposed between the two standing plates 11 and located close to the guide troughs 13 of the two standing plates 11. The press plate 30 has a stay portion 31 at one end thereof close to the guide troughs 13 of the two standing plates 11.

The rotary wheel 40 is pivotally connected between the two standing plates 11 and located close to the guide troughs 13 of the two standing plates 11. The rotary wheel 40 has a plurality of interlaced troughs 41 and slots 42 thereon.

The movable blade unit 50 is pivotally connected between the two standing plates 11, and comprises a movable seat 51, a moveable blade 52 and a spring 53. The movable seat 51 is pivoted close to the guide troughs 13 of the two standing plates 11. The movable seat 51 has a driving portion 511 at one end thereof. The driving portion 511 passes through the guide troughs 13 of the two standing plates 11. The movable seat 51 has a fixing portion 512 at another end thereof. The movable blade 52 is fixed on the fixing portion 512. One end of the movable blade 52 is connected to one end of the spring 53. Another end of the spring 53 is further connected to the base 10.

The fixed blade unit 60 is disposed on one side of the base 10 and located close to the guide troughs 13 of the two standing plates 11. The fixed blade unit 60 comprises a seat 61, a fixed blade 62, a protective piece 63, an elastic member 64 and a lid 65.

The seat 61 has a cutting slot 611 corresponding to the guide troughs 13 of the two standing plates 11. The seat 61 has a chamber 612 facing the side of the base 10. The seat 61 further comprises two positioning posts 613, a connecting post 614, a fixing post 615 and a raised ring 616 which are disposed in the chamber 612.

The fixed blade 62 is disposed in the chamber 612 of the seat 61. The fixed blade 62 has positioning holes 621 corresponding to the positioning posts 613 of the seat 61 to be positioned on the positioning posts 613. The fixed blade 62 has an edge 622 across the cutting slot 611.

The protective piece 63 is made of a transparent material and disposed in the chamber 612 of the seat 61. One end of the protective piece 63 has a connecting hole 631 corresponding to the connecting post 614 of the seat 61 to be connected on the connecting post 614. Another end of the protective piece 63 has a limit slot 632 which is connected with the elastic member 64, such that the protective piece 63 is against one side of the fixed blade 62 opposite to the seat 61 to shield the edge 622 of the fixed blade 62. In this embodiment, the elastic member 64 is a torque spring fixed on the fixing post 615 of the seat 61. Two ends of the elastic member 64 are defined as a fixed end 641 and an elastic end 642. The fixed end 641 is fixed in the raised ring 616 of the seat 61, and the elastic end 642 is confined in the limit slot 632 of the protective piece 63.

The lid 65 is to cover one side of the seat 61 opposite to the base 10. The lid 65 has a notch 651 corresponding to the cutting slot 611 of the seat 61 to form a pair of side walls 652. The lid 65 further has a pair of flanges 653 protruding from the pair of side walls 652 and facing the seat 61.

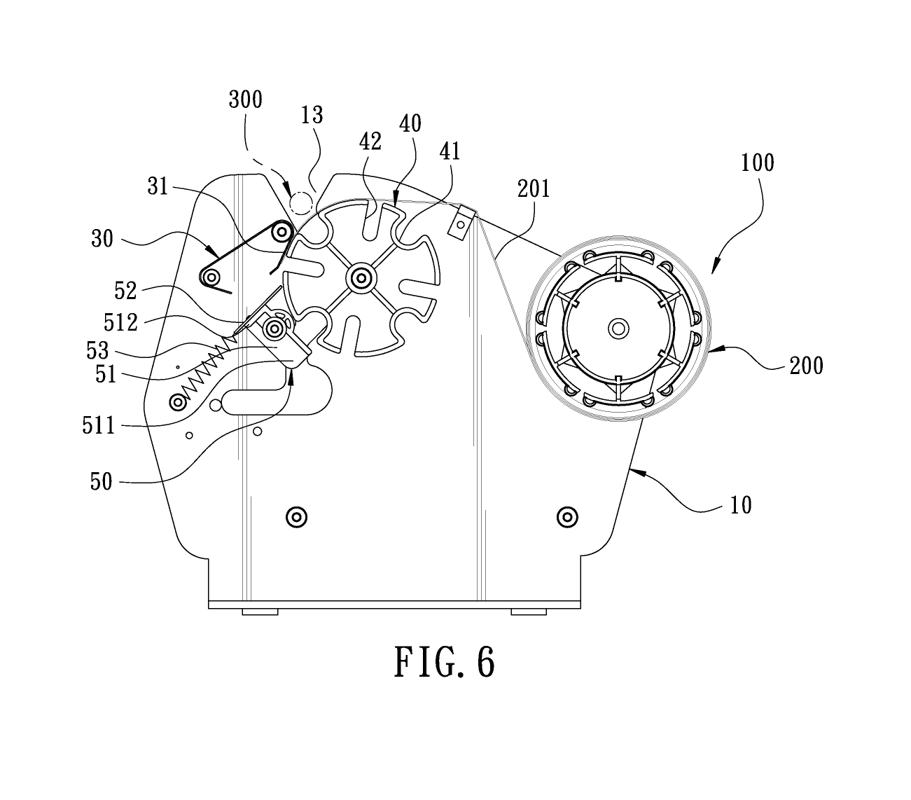

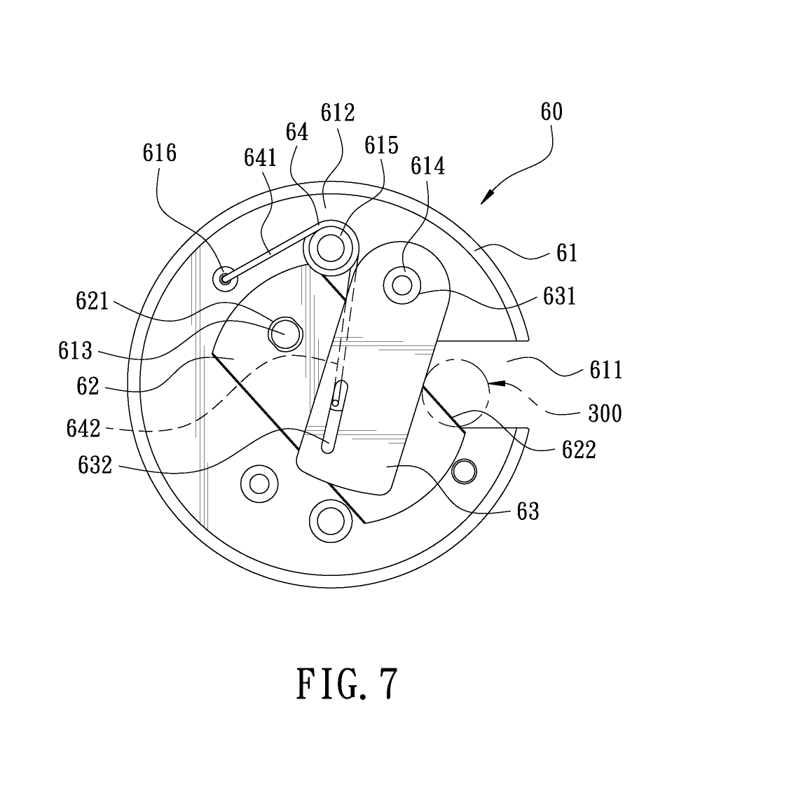

FIG. 6 is a schematic view showing the preferred embodiment of the present invention when in use. FIG. 7 is a schematic view to show the operation of the preferred embodiment of the present invention when in use. Before using the bag neck sealer 100, the user has to install a roll of adhesive tape 200 on the bag neck sealer 100. The installation wheel 20 is taken out from the base 10, and the roll of adhesive tape 200 is installed on the installation wheel 20, and then the installation wheel 20 is placed in the fixing troughs 12 of the two standing plates 11 again. The adhesive tape 201 is pulled out from the roll of the adhesive tape 200 and passes through the upper edge of the rotary wheel 40 to be adhered to the stay portion 31 of the press plate 30, such that the roll of adhesive tape 200 is completely assembled.

After that, the user can proceed to seal a bag 300. The open end of the bag 300 is slid into the trough 41 of the rotary wheel 40 through the guide troughs 13. Because the adhesive tape 201 passes through the upper edge of the rotary wheel 40, the adhesive tape 201 will be adhered on the bag 300 when the open end of the bag 300 is slid into the trough 41. When the bag 300 is continually moved downward, the adhesive tape 201 will be wound on the bag 300 along the rotation of the rotary wheel 40 to tighten the open end of the bag 300. When the bag 300 passes through the movable blade unit 50, the bag 300 will bring the driving portion 511 of the movable seat 51 to turn the movable seat 51, such that the movable blade 52 at the other end of the movable seat 51 is moved toward the rotary wheel 40 to extend into the slot 42 and to cut the adhesive tape 201. Finally, the user moves the bag 300 toward the fixed blade unit 60. As shown in FIG. 7, the bag 300 brings the protective piece 63 to turn, and then the fixed blade 62 is exposed to cut off the unnecessary portion of the bag 300 to complete the seal procedure.

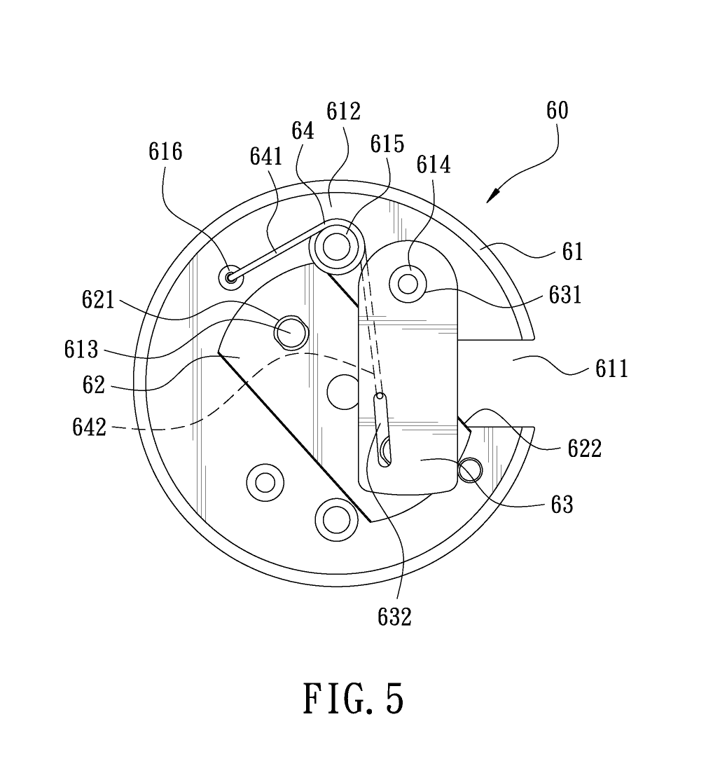

Referring to FIG. 5, the protective piece 63 of the fixed blade unit 60 is against one side of the fixed blade 62 opposite to the base 10 to completely shield the edge 622 of the fixed blade 62. Therefore, when the user operates the bag neck sealer 100, the user's fingers can be protected from the fixed blade 62 through the protective piece 63, preventing the fingers from being hurt so as to enhance the safety of the bag neck sealer 100. Besides, one side of the seat 61 is provided with the lid 65 opposite to the base 10, and the lid 65 has the flanges 653 protruding from the notch 651. When the user operates the bag neck sealer 100, the flanges 653 can protect the user's fingers from the fixed blade 62 to avoid any accident. Furthermore, the protective piece 63 is made of a transparent material, so the user can direct see the fixed blade 62 and check the replacement of the fixed blade 62 when operating the bag neck sealer 100.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A bag neck sealer comprising a base, the base having a guide trough and an installation wheel thereon, a rotary wheel, a press plate and a movable blade unit disposed close to the guide trough, a fixed blade unit disposed on one side of the base and located close to the guide trough, characterized by:
the fixed blade unit having a seat, the seat having a cutting slot corresponding to the guide trough of the base, the seat comprising a fixed blade, the fixed blade having an edge across the cutting slot, the seat further comprising a protective piece, the protective piece being connected with an elastic member to be against one side of the fixed blade opposite to the seat to shield the edge of the fixed blade.

2. The bag neck sealer as claimed in claim 1, wherein the seat has a chamber facing the side of the base, the fixed blade, the protective piece and the elastic member being disposed in the chamber.

3. The bag neck sealer as claimed in claim 2, wherein the seat further comprises two positioning posts disposed in the chamber and the fixed blade has positioning holes corresponding to the positioning posts to be positioned on the positioning posts.

4. The bag neck sealer as claimed in claim 2, wherein the seat further comprises a connecting post disposed in the chamber and the protective piece has a connecting hole corresponding to the connecting post to be connected on the connecting post.

5. The bag neck sealer as claimed in claim 2, wherein the seat further comprises a fixing post and a raised ring which are disposed in the chamber and the protective piece has a limit slot, the elastic member being a torque spring fixed on the fixing post, two ends of the elastic member respectively defining a fixed end and an elastic end, the fixed end being fixed in the raised ring, the elastic end being confined in the limit slot of the protective piece.

6. The bag neck sealer as claimed in claim 1, wherein the fixed blade unit further comprises a lid to cover one side of the seat opposite to the base.

7. The bag neck sealer as claimed in claim 6, wherein the lid has a notch corresponding to the cutting slot of the seat to form a pair of side walls, the lid further having a pair of flanges protruding from the pair of side walls and facing the seat.

8. The bag neck sealer as claimed in claim 1, wherein the protective piece is made of a transparent material.
